(19) United States
(12) Patent Application Publication
(10) Pub. No.: US 2010/0212341 A1
(43) Pub. Date: Aug. 26, 2010

(54) METHODS AND SYSTEMS FOR CONTROLLING A COOLING SYSTEM USING ONE DIGITAL SIGNAL

(75) Inventors: ANDREW JOHN MIKUSZEWSKI, Houston, TX (US); Gregory P. Ziarnik, Houston, TX (US); Mark D. Tupa, Cypress, TX (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY L.P., HOUSTON, TX (US)

(21) Appl. No.: 12/390,612

(22) Filed: Feb. 23, 2009

(51) Int. Cl. G05D 23/00; G05B 15/00

(52) U.S. Cl. 62/157; 700/278

(57) ABSTRACT

Systems and methods that receive a digital signal outputted from a single line of a device are disclosed. Embodiments of the systems and methods calculate the temperature of the device based on the digital signal. Embodiments of the systems and methods generate a signal to a cooling system to cool the device when the calculated temperature of the device is higher than a predetermined temperature.

### BACKGROUND

Devices may not operate properly and may be unreliable if they are operated above a certain temperature. Devices consume power and create heat, which tends to heat the devices. Often cooling systems that use fans are used to cool these devices. The cooling systems may help to ensure that the devices do not overheat, but the cooling systems may create noise and consume power.

Temperature information from the devices can be used to control the cooling systems so that the cooling systems are turned on less frequently. But, it may be hard to convey the temperature information to the cooling system. For example, the temperature information may be susceptible to electronic noise when being sent from the device to the cooling system. Additionally, lines that convey the temperature information may require pins on a device such as an integrated chip in order to send the temperature information to a cooling system and the lines that convey the temperature information may require space to route the signals from the device to the cooling system. For example, the lines that convey temperature information may require room on a printed circuit board.

One solution for conveying temperature information to the cooling system is to apply a voltage to a diode within the device and measure the current through the diode using a line from the device to the cooling system. The amount of current through the diode changes as the temperature changes. This solution has the disadvantage of the current being susceptible to electric noise before being conveyed to the cooling system, and thus not producing an accurate measure of the temperature of the device. Another solution used is a digital read-out from a thermal sensor attached to the device. The digital read-out has the disadvantage of using multiple lines and/or pins available to the device to convey the temperature information.

Therefore there is a need in the art for controlling a cooling system for a device that is less susceptible to electronic noise and that does not use multiple lines.

### BRIEF DESCRIPTION OF THE DRAWINGS

The accompanying drawings are included to illustrate and provide a further understanding of the disclosed embodiments. In the drawings:

FIG. 1 illustrates an embodiment for controlling a cooling system using one digital signal.

FIG. 2a illustrates an embodiment of a digital signal indicating the temperature of the device.

FIG. 2b illustrates an embodiment of a digital signal indicating the temperature of the device.

FIG. 2c illustrates a table for an embodiment of the present invention for setting a fan speed based on the temperature of a device as indicated by a digital signal.

FIG. 3 illustrates an embodiment of a method for controlling a cooling system using one digital signal.

### DETAILED DESCRIPTION

Embodiments of systems and methods receive a digital signal outputted from a single line of a device. Embodiments of systems and methods calculate the temperature of the device based on the digital signal. Embodiments of systems and methods generate a signal to a cooling system to cool the device when the calculated temperature of the device is higher than a predetermined temperature.

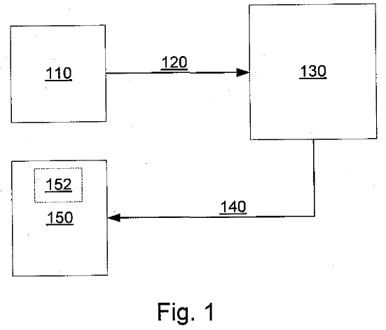

FIG. 1 illustrates an embodiment for controlling a cooling system using one digital signal. The embodiment illustrated includes a heat generating device 110, a line 120, a cooling system controller 130, a line 140, and a cooling device 150.

In operation, the heat generating device 110 may generate a digital signal on the line 120 indicating the temperature of the heat generating device 110. The cooling system controller 130 may calculate the temperature of the heat generating device 110 based on the digital signal generated on the line 120. The cooling system controller 130 may generate a signal on line 140. The cooling device 150 may receive the generated signal on line 140 and adjust the operation of the cooling device 150 based on the generated signal.

In an embodiment, the heat generating device 110 is an electronic device. In an embodiment, the heat generating device 110 is an integrated circuit with a processor and a predetermined number of pins for outputting signals. In an embodiment, the heat generating device 110 includes a circuit for determining the temperature of the heat generating device 110.

In an embodiment, line 120 and/or line 140 are signal lines on a printed circuit board. In an embodiment, line 120 and/or line 140 are copper wires.

In an embodiment, cooling system controller 130 is an integrated circuit with a pin for input of line 120 and at least one pin for output of line 140.

In an embodiment, cooling system 150 may include a fan 155 that operates in proportion to the received signal on line 140. In an embodiment, cooling system 150 is a system for cooling heat generating device 110 such as a cooling system 150 that operates a pump to move fluid to remove heat from heat generating device 110.

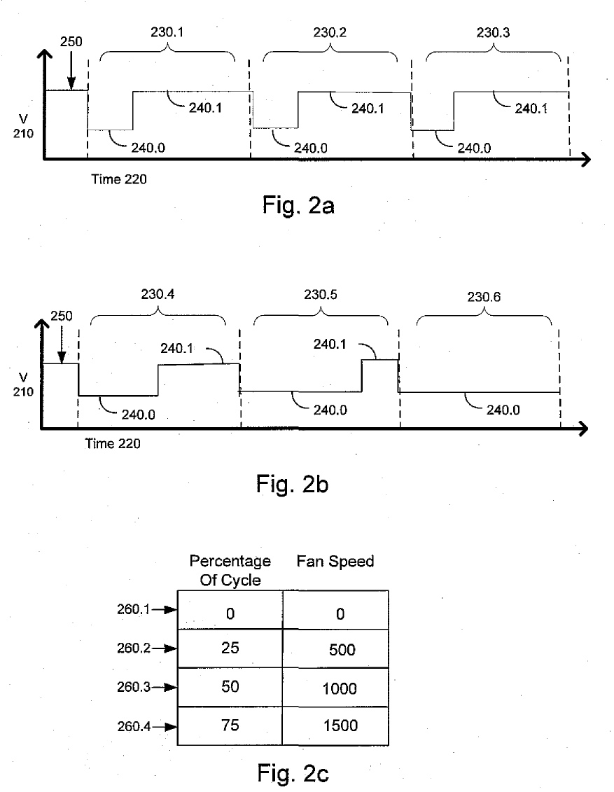

FIG. 2a illustrates an embodiment of a digital signal 250 indicating the temperature of the device. The vertical axis of the graph is voltage 210 and the horizontal axis of the graph is time 220. The signal 250 as illustrated is either high 240.1 or low 240.0. There are three full cycles 230 illustrated. In an embodiment, the digital signal 250 is a pulse width modulated signal with the temperature of the device indicated as a percentage of the time the signal is high 240.1 for a cycle 230. For example, in cycles 230.1, 230.2, and 230.3 the signals are at a zero (0) state 240.0 for twenty-five percent (25%) of the cycle 230 and at a one (1) state for seventy-five percent (75%) of the cycle 230. In an embodiment, cycles 230.1, 230.2, and 230.3 indicate that the temperature of the device is seventy-five percent (75%) of a maximum temperature. The percentage of time that a signal is high during a cycle may be called a duty cycle. It should be understood that the values stated herein, such as 25 percent, 75 percent, 100 percent, and the stated revolutions per minutes (RPM) can be at or approximate to those stated values.

FIG. 2b illustrates an embodiment of a digital signal 250 indicating the temperature of the device. Cycle 230.4 illustrates the signal 250 being at a zero (0) state 240.0 for fifty percent (50%) of the cycle 230.4 and being at a one (1) state 240.1 for fifty percent (50%) of the cycle 230.4. In an embodiment, cycle 230.4 indicates that the device is at fifty percent (50%) of a maximum temperature. Cycle 230.5 illustrates the signal 250 being at a zero state (0) for seventy-five percent (75%) of the cycle 230.5 and being at a one (1) state 240.1 for twenty-five percent (25%) of the cycle 230.5. In an embodiment, cycle 230.5 indicates that the device is at twenty-five percent (25%) of a maximum temperature. Cycle 230.6 illustrates the signal 250 being at a zero state (0) for one-hundred percent (100%) of the cycle 230.6 and being at a one (1) state for zero percent (0%) of the cycle. In an embodiment, cycle 230.6 indicates that the device is at zero percent (0%) of a maximum temperature.

FIG. 2c illustrates a table for an embodiment of the present invention for setting a fan 152 speed based on the temperature of a device as indicated by a digital signal. The table illustrates an embodiment for how a fan 152 speed may be set based on the percentage of a cycle that the signal is high. For example, in row 260.1 the percentage of the cycle that the signal is high is zero percent (0%) and the fan 152 speed is set to zero (0). For row 260.2, the percentage of the cycle that the signal is high is twenty-five percent (25%) and the fan 152 speed is set to 500. For row 260.3, the percentage of the cycle that the signal is high is fifty percent (50%) and the fan 152 speed is set to 1000 RPM. For row 260.4, the percentage of the cycle that the signal is high is seventy-five percent (75%) and the fan 152 speed is set to 1500 RPM.

Many different ways of conveying the temperature of the device digitally on the line are possible. For example, the percentage of time that the signal is high may represent a relative temperature, e.g. a percentage above a normal operating temperature. As another example, the percentage of time that the signal is high may represent a temperature related to a temperature scale such as the Celsius or Fahrenheit. For example, the percentage could be one-half the actual temperature of the device in the Celsius scale. As another example, the percentage of time that the signal is high may represent the percentage of the current temperature of the device the device is to a maximum operating temperature of the device. Additionally, there are many different ways for conveying a digital signal on a single line.

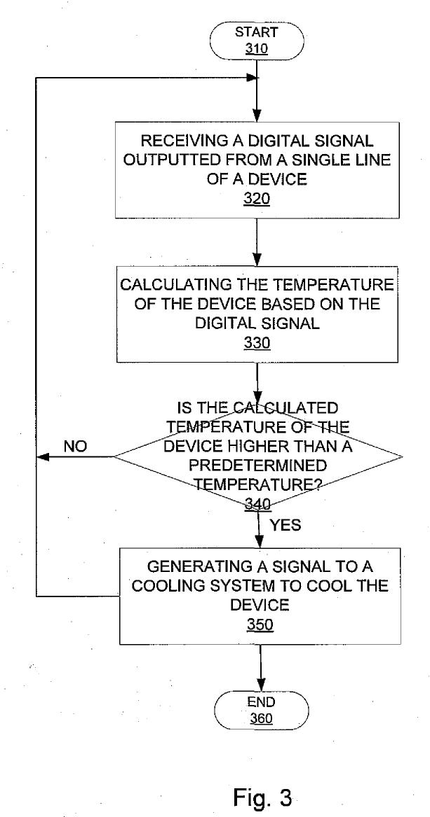

FIG. 3 illustrates an embodiment of a method for controlling a cooling system using one digital signal. The method starts at 310. The method continues at 320 with receiving a digital signal outputted from a single line of a device. For example, in FIG. 1, the cooling system controller 130 receives a digital signal outputted from line 120 of the heat generating device 110. The method continues at 330 with calculating the temperature of the device based on the digital signal. For example, as illustrated in FIG. 2, the temperature of the device may be calculated by calculating the percentage of a cycle that a signal is high. In an embodiment, the temperature is calculated without taking into account any other signal outputted from any line of the device other than the single. The method continues at 340 with: is the calculated temperature of the device higher than a predetermined temperature? For example, in FIG. 1, the cooling system controller 130 may determine that the cooling device 150 does not need to cool the heat generating device 110, unless the heat generating device 110 has conveyed a temperature on line 120 that is above some predetermined temperature. As another example, in FIG. 2c, the fan 152 speed is not set above zero until the percentage of time the high signal is set is greater than zero. The temperature that is conveyed by the percentage of time the high signal is set may be the percent of the temperature above a normal operating temperature so that a value of 25% may represent that the device is 25% above normal operating temperature. In an embodiment, the method returns to 320 if the temperature is not above a predetermined temperature. In an embodiment, if the temperature is above a predetermined temperature, the method continues at 350 with generating a signal to a cooling system to cool the device. For example, the cooling system controller 130 may generate a signal on line 140 to cooling device 150. The cooling device 150 may directly apply the signal to a cooling device such as a fan 152 or the cooling device 150 may include a circuit for interpreting the signal. As another example, as illustrated in FIG. 2c row 260.3, the cooling system controller 130 may generate a signal on line 140 to a fan 152 to operate at a speed of 1000 RPM. In an embodiment, the method may end 360 or the method may repeat at 320.

Embodiments have the advantage that since the temperature information is conveyed digitally, the temperature information is not highly sensitive to noise.

Embodiments have the advantage that since the temperature is conveyed on a signal line, less space may be used to convey the temperature information. Embodiments have the advantage that for integrated circuits that only a single pin of the integrated circuit is used to convey the temperature information.

Various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method, the method comprising:
receiving a digital signal outputted from a single line of a device;
calculating the temperature of the device based on the digital signal without taking into account any other signal outputted from any line of the device other than the single line; and
generating a signal to a cooling system to cool the device when the calculated temperature of the device is higher than a predetermined temperature.

2. The method of claim 1, wherein calculating further comprises:
calculating the temperature of the device based on the digital signal by calculating a percentage of a duty cycle of a pulse width modulated signal of the digital signal; and wherein generating further comprises:
generating a signal to a cooling system to cool the device by operating a fan at a speed proportional to the calculated percentage.

3. The method of claim 1, further comprising:
determining, by the device, the temperature of the device; and
generating, by the device, on a single line a digital signal to indicate the determined temperature of the device.

4. The method of claim 1, further comprising:
determining, by the device, the temperature of the device; and
generating, by the device, on a single line a pulse width modulated signal with the duty cycle proportional to the determined temperature of the device.

5. The method of claim 1, wherein the device is a processor and the one line uses a single pin of an integrated chip of the processor.

6. The method of claim 1, wherein generating a signal to a cooling system further comprises:
generating a signal to a cooling system to cool the device proportionally to the calculated temperature when the calculated temperature of the device is higher than a predetermined temperature.

7. The method of claim 1, wherein calculating further comprises:
calculating the temperature to be higher than a predetermined temperature when the digital signal indicates the device has reached a maximum safe operating temperature.

8. The method of claim 1, further comprising:
receiving, by the cooling system, the signal; and
operating a fan speed based on the signal.

9. A cooling system controller circuit, the circuit configured to:
receive a digital signal outputted from a single line of a device;
calculate the temperature of the device based on the digital signal without taking into account any other signal outputted from any line of the device other than the single line; and
generate a signal to a cooling system to cool the device when the calculated temperature of the device is higher than a predetermined temperature.

10. The circuit of claim 9, wherein calculate further comprises:
calculate the temperature of the device based on the digital signal by calculating a percentage of a duty cycle of a pulse width modulated signal of the digital signal; and wherein generate further comprises:
generate a signal to the cooling system to cool the device by operating a fan at a speed proportional to the calculated percentage.

11. The circuit of claim 9, wherein the device is configured to:
determine the temperature of the device; and
generate on a single line a digital signal to indicate the determined temperature of the device.

12. The circuit of claim 9, wherein the device is configured to:
determine the temperature of the device; and
generate on a single line a pulse width modulated signal with the duty cycle proportionate to the determined temperature of the device.

13. The circuit of claim 9, further configured to:
generate a signal to a cooling system to cool the device proportionate to the calculated temperature when the calculated temperature of the device is higher than a predetermined temperature.

14. The circuit of claim 9, further comprising:
a cooling system including a fan.

15. A system for controlling the temperature of a device, comprising:
a cooling system controller circuit for determining a temperature of the electronic device based on a generated digital that is received from a single line of the device and without taking into account any other signal outputted from any line of the device other than the single line in calculating the temperature, and for generating a signal outputted to a cooling system to turn a cooling system on when the temperature of the device is above a predetermined temperature.

16. The system of claim 15, wherein the device is configured to:
generate on a single line a digital signal indicating the temperature of the device.

17. The system of claim 16, wherein the temperature is indicated by a percentage of a duty cycle of a pulse width modulated signal.

18. The system of claim 16, wherein the device is an integrated circuit and the single line uses a single pin of the integrated circuit.

19. The system of claim 15, wherein the cooling system controller circuit determines the temperature by calculating a percentage of a duty cycle of a pulse width modulated signal of the digital signal; and
wherein the cooling system controller circuit generates the signal outputted to the cooling system to operate a fan at a speed proportional to the calculated percentage of the duty cycle.

20. The system of claim 15, wherein the cooling system control circuit generates a signal to a cooling system to cool the device proportionally to the calculated temperature when the calculated temperature of the device is higher than a predetermined temperature.
